(19) United States
(12) Patent Application Publication
(10) Pub. No.: US 2019/0380012 A1
(43) Pub. Date: Dec. 12, 2019

(54) METHOD AND SYSTEM FOR FACILITATING DATA COMMUNICATION BETWEEN PUBLISHERS AND APPLICATIONS

(71) Applicant: GM GLOBAL TECHNOLOGY OPERATIONS LLC, Detroit, MI (US)

(72) Inventors: Fan Bai, Ann Arbor, MI (US); Markus Jochim, Troy, MI (US); Douglas C. Martin, Goodrich, MI (US)

(21) Appl. No.: 16/001,538

(22) Filed: Jun. 6, 2018

(51) Int. Cl. H04W 4/40; H04L 29/08

(52) U.S. Cl. CPC H04W 4/40; H04L 67/10

(57) ABSTRACT

A system and method for facilitating data communication between publishers and applications is disclosed. The method includes receiving, by a processor of an interface platform, published data from a plurality of publishers. The method also includes receiving a plurality of requests for published data from a plurality of applications. The method also includes aggregating the plurality of requests. The method also includes fulfilling the aggregated requests using the received published data.

### INTRODUCTION

The subject embodiments relate to facilitating data communication between publishers and applications. Specifically, one or more embodiments can be directed to facilitating the communication of vehicle data between publishers of the vehicle data and the applications which use the vehicle data, for example.

Data publishers are devices which release captured data in a particular format for use by others. For example, data publishers can correspond to vehicle sensors which measure a particular parameter relating to vehicle operation, and these data publishers can release their data in a format for use by different applications. These applications can perform analysis on the received data in order to provide functionality including, but not limited to, improving vehicle performance, performing vehicle diagnostics, performing road diagnostics, improving travel experience, identifying possible design improvements, and/or performing tests of vehicle components, for example.

### SUMMARY

In one exemplary embodiment, a method includes receiving, by a processor of an interface platform, published data from a plurality of publishers. The method also includes receiving a plurality of requests for published data from a plurality of applications. The method also includes aggregating the plurality of requests. The method also includes fulfilling the aggregated requests using the received published data.

In addition to one or more of the features described herein, M connections are established between the M publishers and the interface platform, and N connections are established between the interface platform and the N applications.

In addition to one or more of the features described herein, the interface platform is implemented as a cloud-based platform.

In addition to one or more of the features described herein, the published data includes published vehicle sensor data.

In addition to one or more of the features described herein, the aggregated requests include requests for published information corresponding to at least one vehicle identification number.

In addition to one or more of the features described herein, the published vehicle sensor data includes at least one of a vehicle speed, a vehicle wiper speed, and a sensed temperature.

In addition to one or more of the features described herein, the request for published data includes a sampling requirement and a precision requirement.

In addition to one or more of the features described herein, the plurality of requests include a request to synthesize the published data.

In addition to one or more of the features described herein, fulfilling the aggregated requests includes referencing a business logic engine to determine whether the request should be fulfilled.

In addition to one or more of the features described herein, receiving the published data includes storing the published data on a data repository of the interface platform.

In another exemplary embodiment, also described is a system within an interface platform includes an electronic controller configured to receive published data from a plurality of publishers. The electronic controller is also configured to receive a plurality of requests for published data from a plurality of applications. The electronic controller is also configured to aggregate the plurality of requests. The electronic controller is also configured to fulfill the aggregated requests using the received published data.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 illustrates a conventional approach of communicating vehicle data between publishers and a plurality of applications;

FIG. 2 illustrates a system architecture in accordance with one or more embodiments of the invention;

FIG. 3 illustrates a process for providing vehicle data to an application in accordance with one or more embodiments;

FIG. 4 illustrates a process for performing up/down sampling and for modifying the precision of vehicle data in accordance with one or more embodiments;

FIG. 5 illustrates a process for synthesizing vehicle data in accordance with one or more embodiments;

FIG. 6 depicts a flowchart of a method in accordance with one or more embodiments; and

FIG. 7 depicts a high-level block diagram of a computer system, which can be used to implement one or more embodiments of the invention.

### DETAILED DESCRIPTION

The following description is merely exemplary in nature and is not intended to limit the present disclosure, its application or uses. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

One or more embodiments of the invention are directed to a method and system that facilitates the communication of vehicle data between different publishers and different applications. Specifically, one or more embodiments can use in-network computation capabilities to flexibly share, process, manipulate and synthesize vehicle data to serve different applications with different requirements. One or more embodiments can optimize and automate a process of selecting data streams that are published by different vehicle sensors. The system of one or more embodiments can aggregate requests from different applications. The system of one or more embodiments can then manipulate, process, and synthesize data that is received from publishers in order to serve the aggregated requests of the different applications.

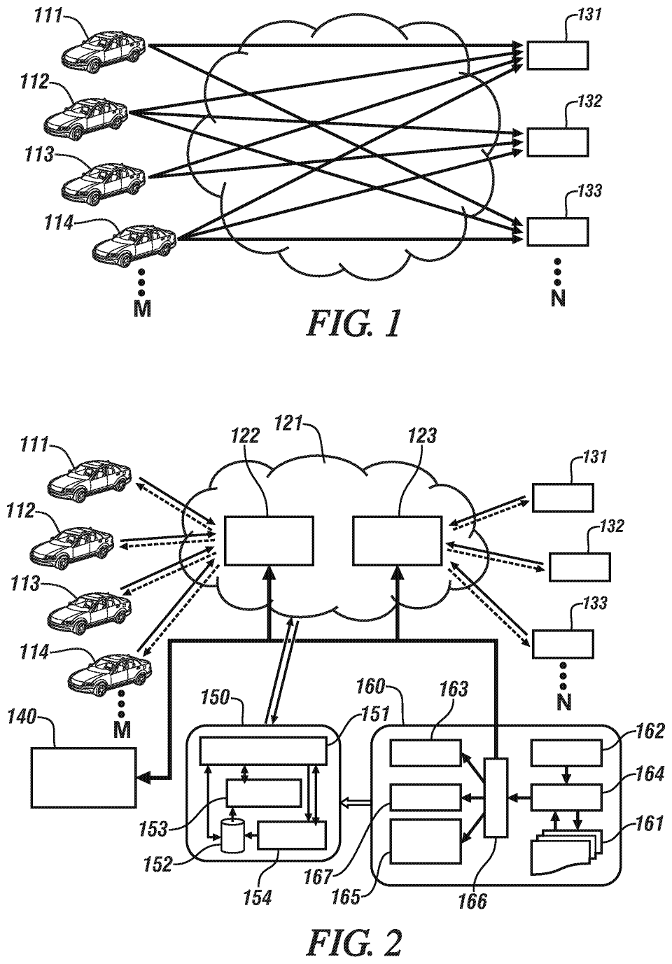

FIG. 1 illustrates a conventional approach of communicating vehicle data between publishers 111, 112, 113, 114 and a plurality of applications 131, 132, 133. Referring to the example of FIG. 1, an “M” number of publishers publish their data to an “N” number of subscribers. Each of the M publishers can be configured to publish their data in accordance with a specific format/precision, and each of the N subscribers may need to receive data in a specific format as well. Each publisher can publish data relating to a specific vehicle. A vehicle can be associated with a plurality of publishers. Publishers 111, 112, 113, 114 can correspond to publishers of a single vehicle, or publishers 111, 112, 113, 114 can correspond to publishers 111, 112, 113, 114 of different vehicles.

Suppose that publisher 111 publishes a vehicle speed to different applications. Further suppose that application 131 needs to receive vehicle-speed data in the format of integer values at a 2 Hz frequency, and suppose that application 133 needs to receive vehicle-speed data in the format of double values at a 2 Hz frequency. Therefore, in order for publisher 111 to publish its vehicle-speed information to application 131 and to application 133, publisher 111 needs to configure two separate connections to each of the applications (where each connection is configured to transmit data in accordance with the required format/precision of each application, and each connection is configured to transmit data in accordance with the required frequency of each application, for example). Further, in addition to publishing vehicle-speed data, publisher 111 and the other publishers can publish other types of data such as, but not limited to, vehicle wiper data, vehicle temperature data, vehicle acceleration data, etc. Further, as described above, each application may need to receive data in a specific format, at a specific frequency. In one example embodiment, different formats/precisions can correspond to different number types such as, for example, float numbers, integer numbers, double numbers, etc. It should be appreciated that examples of differences in format are not limited to numeric values, but include other data types such as, text strings, pointers, tagged data, data represented in data exchange formats (such as for instance XML) or any type of complex data types composed of a variety of these and other basic data types. Therefore, in order to accommodate the specific needs of each application, the conventional approaches generally need to establish a separate connection between each publisher and each application.

However, when using the conventional approaches, if each of the “M” number of publishers 111, 112, 113, 114 connects to each of the “N” number of applications 131, 132, 133, then a total of M×N connections are necessary. However, establishing and maintaining such a large number of connections is very unwieldy and computationally expensive. As described in further detail below, the conventional approaches are generally inefficient and wasteful of bandwidth and computational resources.

In view of the difficulties and shortcomings associated with the conventional approaches, one or more embodiments of the invention can be directed to a system that acts as an interface between the publishers 111, 112, 113, 114 and the applications 131, 132, 133. As described in more detail below, the interface of one or more embodiments reduce the number of connections that are necessary for communicating the information from the publishers 111, 112, 113, 114 to the applications 131, 132, 133. Specifically, instead of requiring N×M connections, one or more embodiments can use N+M connections.

The interface of one or more embodiments can also more efficiently use the available bandwidth when communicating the information from the publishers 111, 112, 113, 114 to the applications 131, 132, 133. As described in more detail herein, one or more embodiments of the invention can aggregate data that is received from a plurality of vehicles/publishers 111, 112, 113, 114, and one or more embodiments can store such aggregated data within a cloud-based storage system. One or more embodiments can also aggregate the different requests/needs of the plurality of applications. Next, with one or more embodiments, the interface can manipulate, process, and synthesize the aggregated data in order to fulfill the aggregated requests, as described in more detail herein. As such, the requests of the applications 131, 132, 133 can be satisfied without requiring each application 131, 132, 133 to directly connect to each publisher 111, 112, 113, 114. As such, the requests of the applications 131, 132, 133 can be satisfied without requiring N×M connections between the publishers 111, 112, 113, 114 and the applications 131, 132, 133.

Additionally, one or more embodiments can isolate the processes relating to control-plane management and the processes relating to data-plane operations, as described in more detail herein. Further, one or more embodiments can enable flexible data processing, data manipulation, data synthesis, and data sharing. One or more embodiments can also introduce admission control algorithms that are aware of business policies, which can enable giving preferences to requests for data that are considered to be more important than other requests for data.

FIG. 2 illustrates a system architecture in accordance with one or more embodiments. The system 121 of one or more embodiments can function as an interface between the publishers 111, 112, 113, 114 and the applications 131, 132, 133. In one or more embodiments, system 121 can be a cloud-driven advanced knowledge broker and exchange platform.

Referring to FIG. 2, an application 131, 132, 133 can request a certain type of vehicle data. In one or more embodiments, the request can be formatted to indicate: (1) the requesting application 131, 132, 133, (2) the requested vehicle data, (3) a requested sampling rate, and/or (4) a requested precision and format, for example. In other embodiments, the request can include more or less parameters.

Upon receiving the request for vehicle data, the cloud-driven broker and exchange platform 121 can communicate with a control-plane decision engine 160 to determine if the received request can be fulfilled in view of the limited communication resources. For example, the control-plane decision engine 160 can determine if the received request can be fulfilled in view of communication bandwidth and computation load limitations. The control-plane decision engine 160 can also be implemented within the cloud.

Specifically, an admission control module 162 can determine if the request can be granted or re-negotiated. If the request cannot be granted or re-negotiated, then the admission control module 162 can reject the request. If the admission control module 162 grants the request, the admission control module 162 transmits the request to a contract enforcement module 164 for execution planning purposes.

The contract enforcement module 164 can reference a business policy engine/book 161 to determine how the contract can be enforced. Each different application 131, 132, 133 can have different contract terms and/or different payment terms with the system 121 or with the subscribers 131, 132, 133 which can enable preferential treatment for certain application requests over other application requests. The contract enforcement module 164 can also determine whether any operations need to be performed on the data to properly fulfill the requests of the applications 131, 132, 133. For example, the contract enforcement module 164 can forward the request to an operation decision module 166 to determine if any operation needs to be performed. For example, up/down sampling module 163 determines whether up/down sampling is necessary to be performed. Precision control module 167 determines whether an increase/decrease in data precision and/or a change in data format is necessary. Synthesis module 165 determines whether synthesizing multiple information is necessary, for example.

Once the control-plane decision engine 160 determines whether any operations are needed to be performed on the data to properly fulfill the requests of the applications 131, 132, 133, detailed instructions regarding how to perform the operations are transmitted to data-plane operation module 150 via a data-plane operation interface 154. Data-plane operation module 150 then executes the detailed operations.

The cloud-driven broker and exchange platform 121 subscribes to the published data based on the aggregated requests from all the different applications 131, 132, 133. The cloud-driven broker and exchange platform 121 also stores the published data (such as vehicle sensor data) in the publish/subscribe computing platform 122, a vehicle computing platform 140, and/or the data-plane operation module 150. Depending on the data operation decisions that are made by the control-plane decision engine 160, the corresponding data-plane operation module 154 will retrieve the vehicle sensor data from the publish/subscribe computing platform 122 for further operations. As described above, the further operations can include: (1) up-sampling/down-sampling, (2) data precision and format changes, and/or (3) knowledge synthesis through multiple sources of vehicle sensors, for example.

The resulting processed data from these operations can be transmitted to a database module 152 via a message search/retrieval interface 151. The resulting processed data can also be updated with relevant data index management by an index management system 153 to keep the data consistent/complete. The data that is requested by the applications 131, 132, 133 is served using an information/insight computing platform 123, but each application 131, 132, 133 receives data in the sampling rate and/or precision and format changes that is required. Each application 131, 132, 133 can receive data in accordance with a sampling rate and/or a precision format that is different from the sampling rate and/or precision and format that other applications 131, 132, 133 use to receive data.

In one or more embodiments of the invention, in the event that system 121 can only support a limited number of application requests, the admission control module 162 can determine the most valuable/suitable requests to fulfill. The determination of the requests to be fulfill can be based on: (1) the combination of requests that provide greater income, (2) the combination of requests that can be fulfilled with less communication cost, and/or (3) the combination of requests that can be fulfilled with less cloud computation cost. A weighted multi-criteria function can be based on the above criteria (1)-(3), and each possible combination can be associated with a value that is derived from the weighted multi-criteria function. As such, the combinations of requests that have the higher function values can be prioritized above other combinations of requests. Other embodiments can use a local, greedy algorithm to assign an income-to-cost ratio for each request to fulfill, where the requests with higher ratio values can be prioritized above other requests.

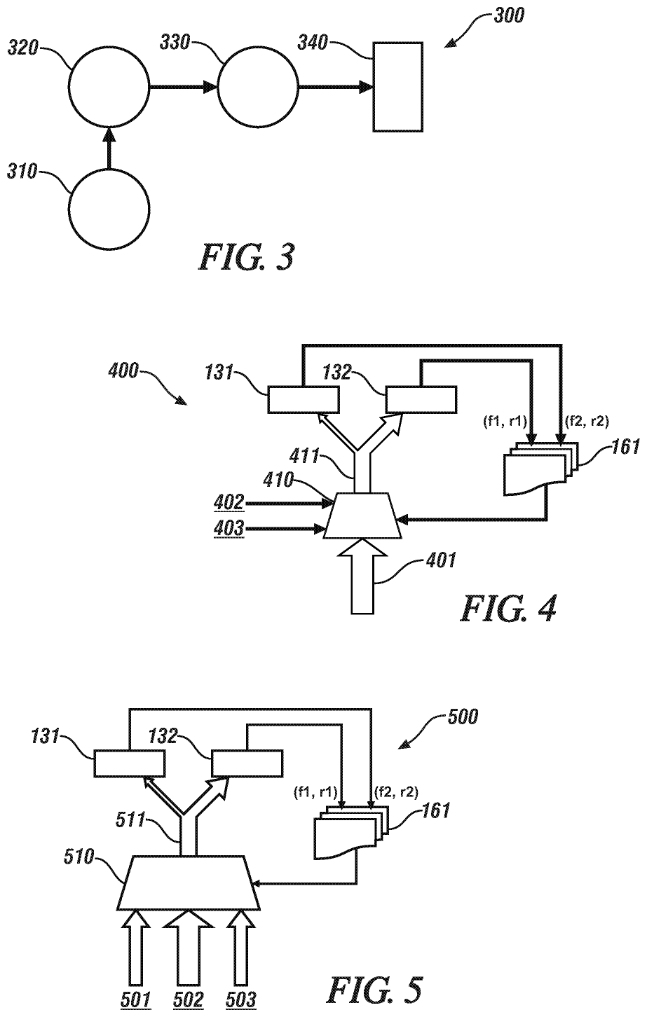

FIG. 3 illustrates a process 300 for providing vehicle data to an application 131, 132, 133 in accordance with one or more embodiments. In the example of FIG. 3, suppose that, at 310, a back office data server (such as, for example, system 121) receives and aggregates vehicle data relating to brake usage, and further suppose that this data relating to brake usage is associated with the vehicle identification number (VIN) of each vehicle from which the data originates from. The back office data server can be implemented anywhere within the cloud-driven advanced knowledge broker and exchange platform of FIG. 2, for example. Next, at 320, suppose that an application 131, 132, 133 requests to receive the vehicle data relating to brake usage. This application can be an application that analyzes brake usage, for example. In the example of FIG. 3, suppose that the brake usage analysis application specifically requests brake usage data that meets two criteria: (1) the brake usage data must be from vehicles which use a specific brake system of type “X”, and (2) the brake usage data must be from vehicles with a driver/user who uses the brake heavily (as determined by a list of VIN numbers that are provided by the application 131, 132, 133, which correspond to vehicles with heavy brake users). At 330, a system within the back office performs the function of aggregating the requests of the application 131, 132, 133. As such, at 340, the back office provides brake usage data to the brake usage analysis application. The provided brake usage data meets the criteria of: (1) being from vehicles which use a specific brake system of type “X”, and (2) being from vehicles with a driver/user who uses the brake heavily. Brake usage data from light braking drivers is not provided to the application. Also, brake usage data from vehicles which use a different brake system of type “Y” is also not provided to the application.

FIG. 4 illustrates a process 400 for performing up/down sampling and for modifying the precision or format of vehicle data in accordance with one or more embodiments. In the example of FIG. 4, suppose that example application 131 and example application 132 both request vehicle speed data. Example application 131 requests vehicle speed data at a specific sampling rate “f1,” and also requests vehicle speed data at a precision “r1.” On the other hand, example application 132 requests vehicle speed data at a specific sampling rate “f2,” and also request vehicle speed data at a precision “r2.” As described above with respect to FIG. 3, a system of the back office can function as a filter/converter 410 of data. For example, up/down sampling module 163 and precision control module 167 (of FIG. 2) can decide to use filter/converter 410 to filter/convert data. Filter/converter 410 can receive vehicle speed data 401 from the data publishers 111, 112, 113, 114. Filter/converter 410 can also receive an input corresponding to the requested data precision 402 (i.e., precision “r1” and precision “r2”) and another input corresponding to the requested sampling rate 403 (i.e., sampling rate “f1” and sampling rate “f2”). Next, if the requests of the applications 131, 132, 133 are determined to be allowable by a business policy engine 161 (as shown in FIG. 2), then the filter/converter 410 produces data 411 that is to be provided to the applications 131, 132, 133. The processed data that is produced by filter/converter 410 is then provided to each of application 131 and application 132. The data 411 that is provided to application 131 is provided at the requested sampling rate of “f1” and at the requested precision of “r1.” The data 411 that is provided to application 132 is provided at the requested sampling rate of “f2” and at the requested precision of “r2.”

FIG. 5 illustrates a process 500 for synthesizing vehicle data in accordance with one or more embodiments. In the example of FIG. 5, suppose that example application 131 and example application 132 both request information regarding a rain/snow intensity data 511. Example application 131 requests rain/snow intensity data 511 at a specific sampling rate “f1,” and also requests rain/snow intensity data at a precision “r1.” On the other hand, example application 132 requests rain/snow intensity data 511 at a specific sampling rate “f2,” and also requests rain/snow intensity data 511 at a precision “r2.” As described above with respect to FIG. 3, a system of the back office can function as a knowledge synthesizer 510 of data. Synthesis decision module 165 can decide to use knowledge synthesizer 510 to synthesize data, for example. The knowledge synthesizer 510 of data can receive humidity data 501, wiper data 502, and temperature data 503, and the like from the data publishers. The synthesizing of this data from the data publishers can facilitate forming rain/snow intensity data 511. Next, if the requests of the applications 131, 132, 133 are determined to be allowable by business policy engine 161, then the knowledge synthesizer 510 produces data 511 that is to be provided to the applications 131 and 132. The data 511 that is produced by the knowledge synthesizer 510 is then provided to each of application 131 and application 132. The rain/snow intensity data 511 that is provided to application 131 is provided at the requested sampling rate of “f1” and at the requested precision of “rt.” The rain/snow intensity data 511 that is provided to application 132 is provided at the requested sampling rate of “f2” and at the requested precision of “r2.”

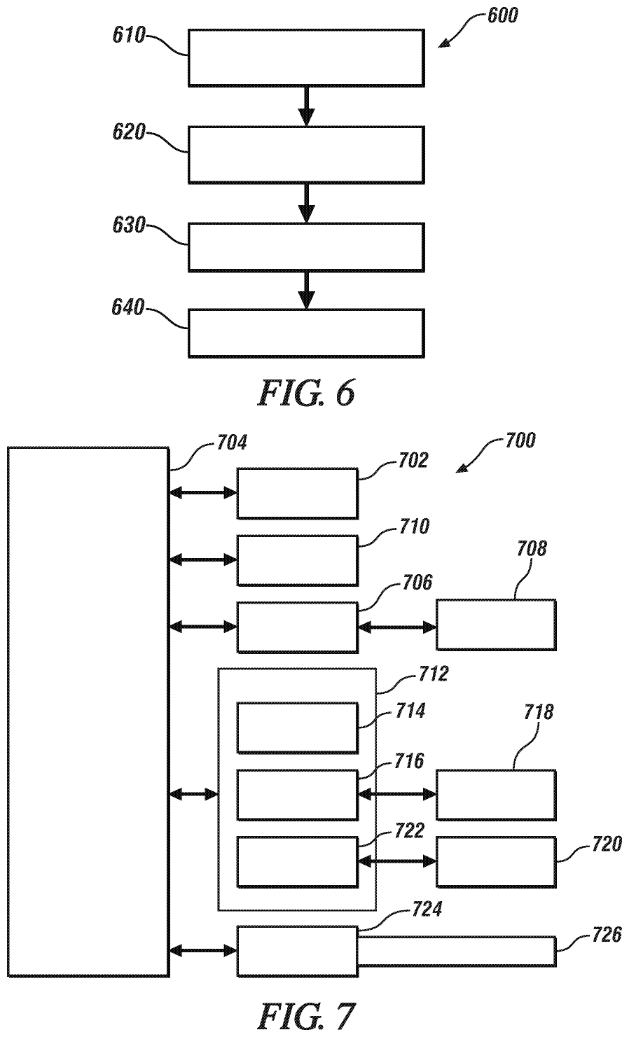

FIG. 6 depicts a flowchart of a method 600 in accordance with one or more embodiments. The method of FIG. 6 can be performed in order to facilitate data communication between publishers 111, 112, 113, 114 and applications 131, 132, 133. The method of FIG. 6 can be performed by a cloud-driven advanced knowledge broker and exchange platform. The platform can be implemented as an interface between data publishers 111, 112, 113, 114 and applications 131, 132, 133, for example. The method can include, at block 610, receiving, by a processor of an interface platform, published data from a plurality of publishers 111, 112, 113, 114. The method can also include, at block 620, receiving a plurality of requests for published data from a plurality of applications 131, 132, 133. The method can also include, at block 630, aggregating the plurality of requests. The method can also include, at block 640, fulfilling the aggregated requests using the received published data.

FIG. 7 depicts a high-level block diagram of a computing system 700, which can be used to implement one or more embodiments. Computing system 700 can correspond to, at least, a system that is configured to facilitate data communication between publishers 111, 112, 113, 114 and applications 131, 132, 133, for example. Computing system 700 can be used to implement hardware components of systems capable of performing methods described herein. Although one exemplary computing system 700 is shown, computing system 700 includes a communication path 726, which connects computing system 700 to additional systems (not depicted). Computing system 700 and additional systems are in communication via communication path 726, e.g., to communicate data between them.

Computing system 700 includes one or more processors, such as processor 702. Processor 702 is connected to a communication infrastructure 704 (e.g., a communications bus, cross-over bar, or network, e.g., cellular, WiFi, Internet, and the like). Computing system 700 can include a display interface 706 that forwards graphics, textual content, and other data from communication infrastructure 704 (or from a frame buffer not shown) for display on a display unit 708. Computing system 700 also includes a main memory 710, for example, random access memory (RAM), and can also include a secondary memory 712. There also can be one or more disk drives 714 contained within secondary memory 712. Removable storage drive 716 reads from and/or writes to a removable storage unit 718. As will be appreciated, removable storage unit 718 includes a computer-readable medium having stored therein computer software and/or data.

In alternative embodiments, secondary memory 712 can include other similar means for allowing computer programs or other instructions to be loaded into the computing system. Such means can include, for example, a removable storage unit 720 and an interface 722.

In the present description, the terms “computer program medium,” “computer usable medium,” and “computer-readable medium” are used to refer to media such as main memory 710 and secondary memory 712, removable storage drive 716, and a disk installed in disk drive 714. Computer programs (also called computer control logic) are stored in main memory 710 and/or secondary memory 712. Computer programs also can be received via communications interface 724. Such computer programs, when run, enable the computing system to perform the features discussed herein. In particular, the computer programs, when run, enable processor 702 to perform the features of the computing system 700. Accordingly, such computer programs represent controllers of the computing system 700. Thus it can be seen from the forgoing detailed description that one or more embodiments provide technical benefits and advantages.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the embodiments not be limited to the particular embodiments disclosed, but will include all embodiments falling within the scope of the application.

What is claimed is:

1. A method, the method comprising:
receiving, by a processor of an interface platform, published data from a plurality of publishers;
receiving a plurality of requests for published data from a plurality of applications;
aggregating the plurality of requests; and
fulfilling the aggregated requests using the received published data.

2. The method of claim 1, wherein M connections are established between the M publishers and the interface platform, and N connections are established between the interface platform and the N applications.

3. The method of claim 1, wherein the interface platform is implemented as a cloud-based platform.

4. The method of claim 1, wherein the published data comprises published vehicle sensor data.

5. The method of claim 1, wherein the aggregated requests comprise requests for published information corresponding to at least one vehicle identification number.

6. The method of claim 4, wherein the published vehicle sensor data comprises at least one of a vehicle speed, a vehicle wiper speed, and a temperature associated with a vehicle.

7. The method of claim 1, wherein each request for published data comprises a sampling requirement and a precision requirement.

8. The method of claim 1, wherein the plurality of requests comprise a request to synthesize the published data.

9. The method of claim 1, wherein fulfilling the aggregated requests comprises referencing a business logic engine to determine whether the request should be fulfilled.

10. The method of claim 1, wherein receiving the published data comprises storing the published data on a data repository of the interface platform.

11. A system within an interface platform, comprising:
an electronic controller of the interface platform configured to:
receive published data from a plurality of publishers;
receive a plurality of requests for published data from a plurality of applications;
aggregate the plurality of requests; and
fulfill the aggregated requests using the received published data.

12. The system of claim 11, wherein M connections are established between the M publishers and the interface platform, and N connections are established between the interface platform and the N applications.

13. The system of claim 11, wherein the interface platform is implemented as a cloud-based platform.

14. The system of claim 11, wherein the published data comprises published vehicle sensor data.

15. The system of claim 11, wherein the aggregated requests comprise requests for published information corresponding to at least one vehicle identification number.

16. The system of claim 14, wherein the published vehicle sensor data comprises at least one of a vehicle speed, a vehicle wiper speed, and a vehicle temperature.

17. The system of claim 11, wherein each request for published data comprises a sampling requirement and a precision requirement.

18. The system of claim 11, wherein the plurality of requests comprise a request to synthesize the published data.

19. The system of claim 11, wherein fulfilling the aggregated requests comprises referencing a business logic engine to determine whether the request should be fulfilled.

20. The system of claim 11, wherein receiving the published data comprises storing the published data on a data repository of the interface platform.
